(19) United States
(12) Patent Application Publication
(10) Pub. No.: US 2026/0288217 A1
(43) Pub. Date: Sep. 24, 2026

(54) PSU POWER SHARING VIA UNBALANCED BACKPLANE

(71) Applicant: Lenovo (United States) Inc., Morrisville, NC (US)

(72) Inventor: Omar Ali, Morrisville, NC (US)

(21) Appl. No.: 19/088,656

(22) Filed: Mar. 24, 2025

(51) Int. Cl. G06F 1/26; G06F 1/18

(52) U.S. Cl. CPC G06F 1/26; G06F 1/189

(57) ABSTRACT

In one aspect, a device includes a power distribution board (PDB). The PDB includes a first space for a first power supply unit (PSU) connector, a second space for a second PSU connector, and a third space for a printed circuit board (PCB) connector. The first and second spaces are unequal distances from the third space. The PDB also includes an area that directs power along a first path from the first space to the third space. The first path has a first distance that is equal to a second distance of a second path from the second space to the third space over which power can also travel. This configuration can therefore be used for dual-PSU power sharing notwithstanding an otherwise unbalanced backplane.

### FIELD

The disclosure below relates to technically inventive, non-routine solutions that produce concrete technical improvements. In particular, the disclosure below relates to power supply unit (PSU) power sharing using an otherwise unbalanced backplane.

### BACKGROUND

As recognized herein, it is undesirable to route PSU power to a motherboard (MB) through an MB location proximate to the MB's central processing units (CPUs) since the CPUs themselves can be quite sensitive and can be adversely affected by the relatively strong current nearby.

As also recognized herein, the chassis dimensions of many personal computers (PCs) further limits the locations at which the PSU connectors can be placed. But regardless of location, it has been heretofore undesirable to locate the dual PSU connectors at asymmetric locations relative to the MB connector itself as any such configuration can result in electrical imbalance.

Electrical imbalance is undesirable since, during a power surge, the imbalance can result in overcurrent flowing from the nearest PSU to the MB connector, causing the system to shut down. There are currently no adequate solutions to the foregoing technological problem.

### SUMMARY

Accordingly, in one aspect a device includes a power distribution board (PDB). The PDB includes a motherboard (MB) connector, a first power supply unit (PSU) connector electrically coupled to the MB connector, and a second PSU connector electrically coupled to the MB connector. The first PSU connector is located more proximate to the MB connector than the second PSU connector is located to the MB connector. The device also includes an MB electrically coupled to the MB connector, a processor system coupled to the MB, and storage accessible to the processor system and coupled to the MB. The PDB also includes a void to direct power from the first PSU connector to the MB connector along a first path that has a first distance that is equal, within a threshold tolerance, to a second distance of a second path over which power travels from the second PSU connector to the MB connector.

In some non-limiting examples, the void may be established by an etching in copper of the PDB. Also in some non-limiting examples, the threshold tolerance may be zero such that the first distance is equal to the second distance. In other non-limiting examples, the threshold tolerance may be less than ten millimeters.

In addition, in some implementations the first PSU connector may connect the PDB to a first PSU, and the second PSU connector may connect the PDB to a second PSU. The first and second PSUs may supply power to the device according to a power sharing mode or a redundancy mode but, in either case, the device may also include the first and second PSUs themselves if desired.

What's more, in some embodiments the PDB may itself be established by a printed circuit board (PCB) different from the PCB establishing the MB.

Also, if desired the MB connector may connect the PDB to the MB via a through hole in the device. Also if desired, the storage may include memory such as, but not limited to, one or more dual in-line memory modules (DIMMs). In addition, the processor system may include two central processing units (CPUs) configured on the device to receive power, via the MB connector, from the PDB. Also if desired, the MB connector may include golden fingers.

In another aspect, a device includes a power distribution board (PDB). The PDB includes a printed circuit board (PCB) connector, a first power supply unit (PSU) connector electrically coupled to the PCB connector, and a second PSU connector electrically coupled to the PCB connector. The first PSU connector is located more proximate to the PCB connector than the second PSU connector is located to the PCB connector. The PDB also includes an area that directs power from the first PSU connector to the PCB connector along a first path that has a first distance that is equal, within a threshold tolerance, to a second distance of a second path over which power travels from the second PSU connector to the PCB connector.

In some examples, the PCB connector may be a motherboard (MB) connector that connects the PDB to an MB, and the device may even include the MB itself.

Also in one example implementation, the area may include a non-conductive gap in the PDB, such as a non-conductive gap established by an etching in metal on the PDB. In addition to or in lieu of that, the area may include insulating material (e.g., in the air gap).

What's more, in some embodiments the device may include a first PSU and a second PSU. The first PSU connector may connect the PDB to the first PSU, and the second PSU connector may connect the PDB to the second PSU.

In still another aspect, a device includes a power distribution board (PDB). The PDB includes a first space for a first power supply unit (PSU) connector, a second space for a second PSU connector, and a third space for a printed circuit board (PCB) connector. The first and second spaces are unequal distances from the third space. The PDB also includes an area that directs power along a first path from the first space to the third space. The first path has a first distance that is equal to a second distance of a second path from the second space to the third space over which power can also travel.

### BRIEF DESCRIPTION OF THE DRAWINGS

The details of present principles, both as to their structure and operation, can best be understood in reference to the accompanying drawings, in which like reference numerals refer to like parts, and in which:

FIG. 1 is a block diagram of an example system consistent with present principles;

FIG. 2 is a top plan view of an example motherboard (MB) with backplane underneath consistent with present principles;

FIG. 3 shows an underside exploded partial view of the example backplane consistent with present principles; and

FIG. 4 shows a cross-sectional view of an example PDB located on the backplane consistent with present principles.

### DETAILED DESCRIPTION

Among other things, the detailed description below helps solve mechanical chassis limitations that otherwise result in a power distribution backplane being unbalanced in situations where the system has two PSUs that can operate in a power sharing mode. The disclosure below recognizes that for the power sharing mode, the power distribution backplane should be balanced for the system to work, or else during a power surge one PSU will provide overcurrent and the system will shut down. The insulating area to be discussed below therefore provides advantages over other approaches, such as not even supporting a power-sharing mode and instead only operating in a redundant power mode (in which case a personal computer's higher-powered components/configurations might not all receive adequate power at the same time). Added cables and other added hardware also complicates the design and results in even further chassis limitations.

Therefore, according to present principles, the power shape on the power distribution backplane may be cut (voided) between the PDB-MB connector and the nearest PDB-PSU connector. This forces the electrical current to go around the cut, making the otherwise unbalanced backplane balanced. This allows the device to support both power sharing mode as well as redundant mode.

Prior to delving further into the details of the instant techniques, note with respect to any computer systems discussed herein that a system may include server and client components, connected over a network such that data may be exchanged between the client and server components. The client components may include one or more computing devices including televisions (e.g., smart TVs, Internet-enabled TVs), computers such as desktops, laptops and tablet computers, so-called convertible devices (e.g., having a tablet configuration and laptop configuration), and other mobile devices including smart phones. These client devices may employ, as non-limiting examples, operating systems from Apple Inc. of Cupertino CA, Google Inc. of Mountain View, CA, or Microsoft Corp. of Redmond, WA. A Unix® or similar such as Linux® operating system may be used, as may a Chrome or Android or Windows or macOS or iOS operating system. These operating systems can execute one or more browsers such as a browser made by Microsoft or Google or Mozilla or another browser program that can access web pages and applications hosted by Internet servers over a network such as the Internet, a local intranet, or a virtual private network.

As used herein, instructions refer to computer-implemented steps for processing information in the system. Instructions can be implemented in software, firmware or hardware, or combinations thereof and include any type of programmed step undertaken by components of the system; hence, illustrative components, blocks, modules, circuits, and steps are sometimes set forth in terms of their functionality.

A processor may be any single- or multi-chip processor that can execute logic by means of various lines such as address lines, data lines, and control lines and registers and shift registers. Moreover, any logical blocks, modules, and circuits described herein can be implemented or performed with a system processor such as a central processing unit (CPU), a graphics processing unit (GPU), a neural processing unit (NPU), a digital signal processor (DSP), a field programmable gate array (FPGA) or other programmable logic device such as an application specific integrated circuit (ASIC), discrete gate or transistor logic, discrete hardware components, or any combination thereof designed to perform the functions described herein. A processor can also be implemented by a controller or state machine or a combination of computing devices. Thus, the methods herein may be implemented as software instructions executed by a processor, suitably configured application specific integrated circuits (ASIC) or field programmable gate array (FPGA) modules, or any other convenient manner as would be appreciated by those skilled in the art. Where employed, the software instructions may also be embodied in a non-transitory device that is being vended and/or provided, and that is not a transitory, propagating signal and/or a signal per se. For instance, the non-transitory device may be or include a hard disk drive, solid state drive, or CD ROM. Flash drives may also be used for storing the instructions. Additionally, the software code instructions may also be downloaded over the Internet (e.g., as part of an application (“app”) or software file). Accordingly, it is to be understood that although a software application for undertaking present principles may be vended with a device such as the system 100 described below, such an application may also be downloaded from a server to a device over a network such as the Internet. An application can also run on a server and associated presentations may be displayed through a browser (and/or through a dedicated companion app) on a client device in communication with the server.

Software modules and/or applications described by way of flow charts and/or user interfaces herein can include various sub-routines, procedures, etc. Without limiting the disclosure, logic stated to be executed by a particular module can be redistributed to other software modules and/or combined together in a single module and/ or made available in a shareable library. Also, the user interfaces (UI)/graphical UIs described herein may be consolidated and/or expanded, and UI elements may be mixed and matched between UIs.

Logic when implemented in software, can be written in an appropriate language such as but not limited to hypertext markup language (HTML)-5, Java®/JavaScript, C# or C++, and can be stored on or transmitted from a computer-readable storage medium such as a hard disk drive (HDD) or solid state drive (SSD), a random access memory (RAM), read-only memory (ROM), electrically erasable programmable read-only memory (EEPROM), a hard disk drive or solid state drive, compact disk read-only memory (CD-ROM) or other optical disk storage such as digital versatile disc (DVD), magnetic disk storage or other magnetic storage devices including removable thumb drives, etc.

In an example, a processor can access information over its input lines from data storage, such as the computer readable storage medium, and/or the processor can access information wirelessly from an Internet server by activating a wireless transceiver to send and receive data. Data typically is converted from analog signals to digital by circuitry between the antenna and the registers of the processor when being received and from digital to analog when being transmitted. The processor then processes the data through its shift registers to output calculated data on output lines, for presentation of the calculated data on the device.

Components included in one embodiment can be used in other embodiments in any appropriate combination. For example, any of the various components described herein and/or depicted in the Figures may be combined, interchanged or excluded from other embodiments.

The term “a” or “an” in reference to an entity refers to one or more of that entity. As such, the terms “a” or “an”, “one or more”, and “at least one” can be used interchangeably herein. “A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together, etc.

The term “circuit” or “circuitry” may be used in the summary, description, and/or claims. The term “circuitry” includes all levels of available integration, e.g., from discrete logic circuits to the highest level of circuit integration such as VLSI, and includes programmable logic components programmed to perform the functions of an embodiment as well as processors (e.g., special-purpose processors) programmed with instructions to perform those functions.

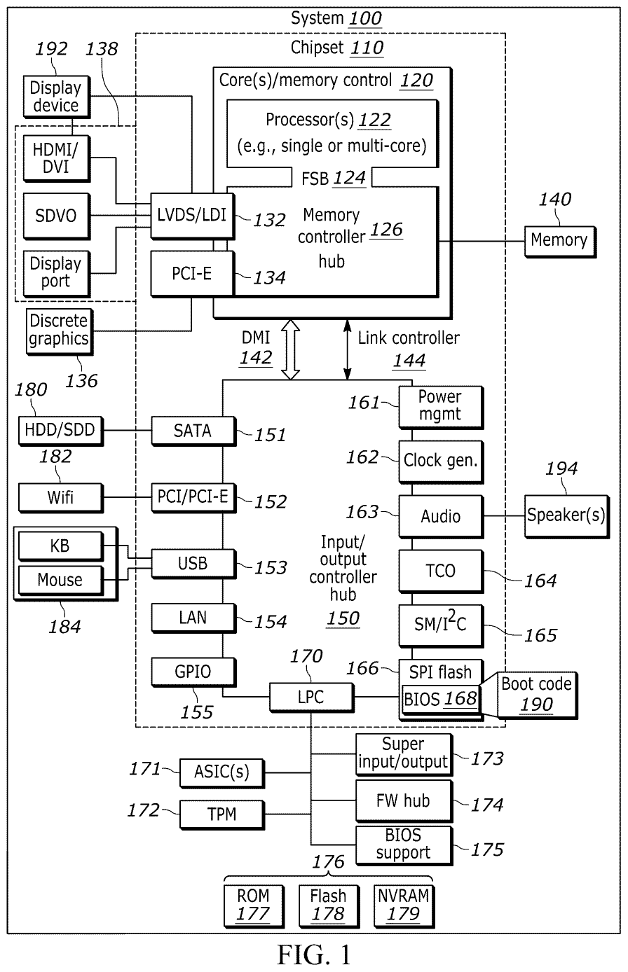

Now specifically in reference to FIG. 1, an example block diagram of an information handling system and/or computer system 100 is shown that is understood to have a housing for the components described below. Note that in some embodiments the system 100 may be a desktop computer system, such as one of the ThinkCentre®, or notebook computer system, such as ThinkPad® series of personal computers sold by Lenovo (US) Inc. of Morrisville, NC, or a workstation computer, such as the ThinkStation®, which are sold by Lenovo (US) Inc. of Morrisville, NC; however, as apparent from the description herein, a client device, a server or other machine in accordance with present principles may include other features or only some of the features of the system 100. Also, the system 100 may be, e.g., a game console such as XBOX®, and/or the system 100 may include a mobile communication device such as a mobile telephone, notebook computer, and/or other portable computerized device.

As shown in FIG. 1, the system 100 may include a so-called chipset 110. A chipset refers to a group of integrated circuits, or chips, that are designed to work together. Chipsets are usually marketed as a single product (e.g., consider chipsets marketed under the brands INTEL®, AMD®, etc.).

In the example of FIG. 1, the chipset 110 has a particular architecture, which may vary to some extent depending on brand or manufacturer. The architecture of the chipset 110 includes a core and memory control group 120 and an I/O controller hub 150 that exchange information (e.g., data, signals, commands, etc.) via, for example, a direct management interface or direct media interface (DMI) 142 or a link controller 144. In the example of FIG. 1, the DMI 142 is a chip-to-chip interface (sometimes referred to as being a link between a “northbridge” and a “southbridge”).

The core and memory control group 120 includes a processor system 122 (e.g., one or more single core or multi-core processors, etc.) and a memory controller hub 126 that exchange information via a front side bus (FSB) 124. A processor system such as the system 122 may therefore include one or more processors acting independently or in concert with each other to execute an algorithm, whether those processors are in one device or more than one device. Additionally, as described herein, various components of the core and memory control group 120 may be integrated onto a single processor die, for example, to make a chip that supplants the “northbridge” style architecture.

The memory controller hub 126 interfaces with memory 140. For example, the memory controller hub 126 may provide support for DDR SDRAM memory (e.g., DDR, DDR2, DDR3, etc.). In general, the memory 140 is a type of random-access memory (RAM). It is often referred to as “system memory.”

The memory controller hub 126 can further include a low-voltage differential signaling interface (LVDS) 132. The LVDS 132 may be a so-called LVDS Display Interface (LDI) for support of a display device 192 (e.g., a CRT, a flat panel, a projector, a touch-enabled light emitting diode (LED) display or other video display, etc.). A block 138 includes some examples of technologies that may be supported via the LVDS interface 132 (e.g., serial digital video, HDMI/DVI, display port). The memory controller hub 126 also includes one or more PCI-express interfaces (PCI-E) 134, for example, for support of discrete graphics 136. For example, the memory controller hub 126 may include a 16-lane (x16) PCI-E port for an external PCI-E-based graphics card (including, e.g., one or more GPUs). An example system may thus include PCI-E for support of graphics.

In examples in which it is used, the I/O hub controller 150 can include a variety of interfaces. The example of FIG. 1 includes a SATA interface 151, one or more PCI-E interfaces 152 (optionally one or more legacy PCI interfaces), one or more universal serial bus (USB) interfaces 153, a local area network (LAN) interface 154 (more generally a network interface for communication over at least one network such as the Internet, a WAN, a LAN, a Bluetooth network using Bluetooth 5.0 communication, etc. under direction of the processor(s) 122), a general purpose I/O interface (GPIO) 155, a low-pin count (LPC) interface 170, a power management interface 161, a clock generator interface 162, an audio interface 163 (e.g., for speakers 194 to output audio), a total cost of operation (TCO) interface 164, a system management bus interface (e.g., a multi-master serial computer bus interface) 165, and a serial peripheral flash memory/controller interface (SPI Flash) 166, which, in the example of FIG. 1, includes basic input/output system (BIOS) 168 and boot code 190. With respect to network connections, the I/O hub controller 150 may include integrated gigabit Ethernet controller lines multiplexed with a PCI-E interface port. Other network features may operate independent of a PCI-E interface. Example network connections include Wi-Fi as well as wide-area networks (WANs) such as 4G and 5G cellular networks.

The interfaces of the I/O hub controller 150 may provide for communication with various devices, networks, etc. For example, where used, the SATA interface 151 and/or PCI-E interface 152 provide for reading, writing or reading and writing information on one or more drives 180 such as HDDs, SSDs or a combination thereof, but in any case the drives 180 are understood to be, e.g., tangible computer readable storage mediums that are not transitory, propagating signals. The I/O hub controller 150 may also include an advanced host controller interface (AHCI) to support one or more drives 180. The PCI-E interface 152 allows for wireless connections 182 to devices, networks, etc. The USB interface 153 provides for input devices 184 such as keyboards (KB), mice and various other devices (e.g., cameras, phones, storage, media players, etc.).

In the example of FIG. 1, the LPC interface 170 provides for use of one or more ASICs 171, a trusted platform module (TPM) 172, a super I/O 173, a firmware hub 174, BIOS support 175 as well as various types of memory 176 such as ROM 177, Flash 178, and non-volatile RAM (NVRAM) 179. With respect to the TPM 172, this module may be in the form of a chip that can be used to authenticate software and hardware devices. For example, a TPM may be capable of performing platform authentication and may be used to verify that a system seeking access is the expected system.

The system 100, upon power on, may be configured to execute boot code 190 for the BIOS 168, as stored within the SPI Flash 166, and thereafter processes data under the control of one or more operating systems and application software (e.g., stored in system memory 140). An operating system may be stored in any of a variety of locations and accessed, for example, according to instructions of the BIOS 168.

Additionally, though not shown for simplicity, in some embodiments the system 100 may include a gyroscope that senses and/or measures the orientation of the system 100 and provides related input to the processor system 122, an accelerometer that senses acceleration and/or movement of the system 100 and provides related input to the processor system 122, and/or a magnetometer that senses and/or measures directional movement of the system 100 and provides related input to the processor system 122.

Still further, the system 100 may include an audio receiver/microphone that provides input from the microphone to the processor system 122 based on audio that is detected, such as via a user providing audible input to the microphone. The system 100 may also include a camera that gathers one or more images and provides the images and related input (e.g., metadata like an image timestamp) to the processor system 122. The camera may be a thermal imaging camera, an infrared (IR) camera, a digital camera such as a webcam, a three-dimensional (3D) camera, and/or a camera otherwise integrated into the system 100 and controllable by the processor system 122 to gather still images and/or video.

Also, the system 100 may include a global positioning system (GPS) transceiver that is configured to communicate with satellites to receive/identify geographic position information and provide the geographic position information to the processor system 122. However, it is to be understood that another suitable position receiver other than a GPS receiver may be used in accordance with present principles to determine the location of the system 100.

It is to be understood that an example client device or other machine/computer may include fewer or more features than shown on the system 100 of FIG. 1. In any case, it is to be understood at least based on the foregoing that the system 100 is configured to undertake present principles.

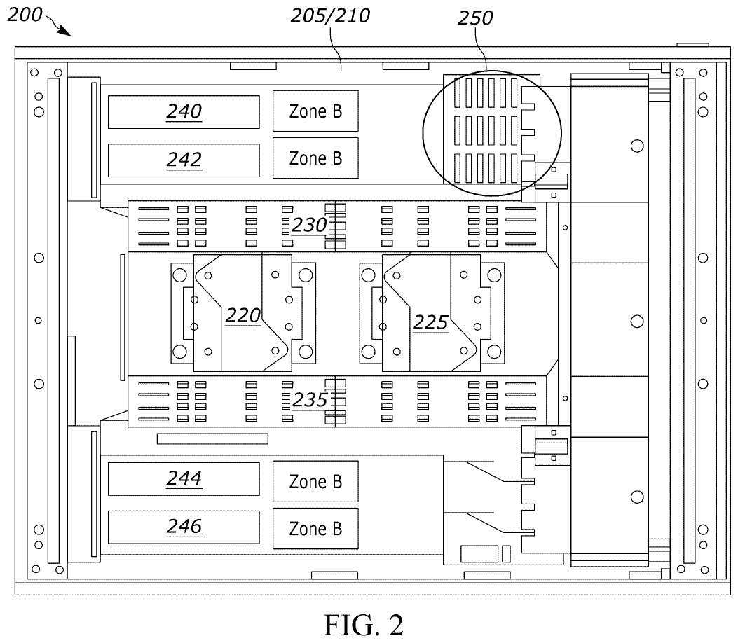

Now in reference to FIG. 2, a top plan view is shown of an example motherboard (MB) 200 or other printed circuit board (PCB) to which computing components may be coupled. The MB 200 may be the MB of a personal computer or other client device, though it might also be the MB of a server as well. Also note that although only partially shown in FIG. 2, a backplane 205 including a power distribution board (PDB) 210 may be mounted underneath the MB 200. The PDB 210 may itself establish a PCB different from the MB 200.

In addition, various computing components may be mounted on top of the MB 200. Specifically, the MB 200 may have a processor system mounted thereto, where the processor system may include dual central processing units (CPUs) 220, 225 in non-limiting examples. However, the processor system may also include other types of processors in addition to or in lieu of CPUs.

The MB 200 may also have computer storage, such as RAM or other non-persistent memory, coupled thereto. In the present example, the RAM includes sixteen dual in-line memory modules (DIMMs). And according to the perspective shown in FIG. 2, eight DIMMs 230 may be located above the CPUs 220, 225, while another eight DIMMs 235 may be located below the CPUs 220, 225.

It is to be further understood that multiple peripheral component interconnect express (PCIe) slots may be included on the MB 200. The PCIe slots may be located, according to the perspective shown in FIG. 2, above and below the DIMMs 230, 235. In one specific non-limiting implementation, four PCIe slots may be located above the DIMMs 230, while five PCIe slots may be located below the DIMMs 235. Each PCIe slot may be a dual-width slot. But regardless of whether dual-width or single-width, each PCIe slot may be configured to receive a different computer card such as an audio card or, in the present example, different graphics cards 240, 242, 244, and 246. Each graphics card 240-246 may include one or more graphics processing units (GPUs).

As also shown in FIG. 2, the MB 200 may have a through hole or other receiver through which an MB/PCB connector 250 of the PDB 210 may be coupled to the MB 200. The MB connector 250 may supply power from one or more power supply units (PSUs) (not shown) that are connected to the PDB 210 itself to thus power the MB 200. The MB connector 250 may include golden (metal) fingers in non-limiting embodiments, though other types of electrical connectors/pins may also be used.

Note that although not shown for clarity, still other computing components may be coupled to the MB 200.

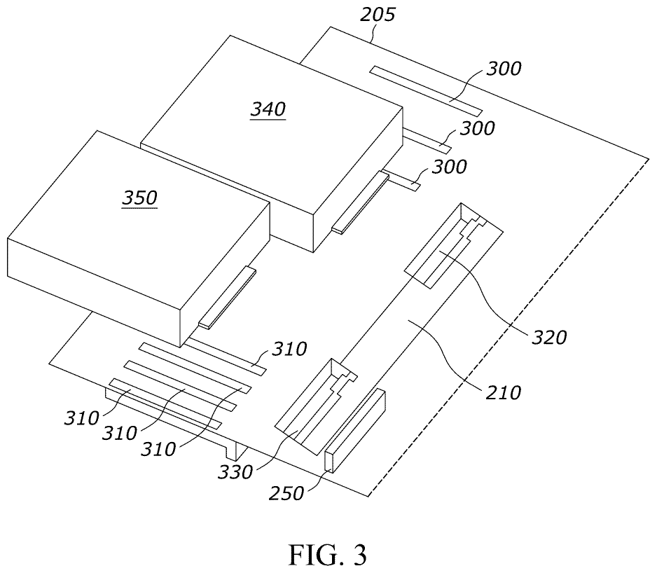

Now in reference to FIG. 3, an underside exploded partial view is shown of the backplane 205 with PDB 210. It may be appreciated from FIG. 3 that certain PCIe slots 300, 310 as described above may extend through the backplane 205. Further note that the MB connector 250 may be electrically coupled, via the PDB 210, to a first PSU connector 320 and to a second PSU connector 330. The first PSU connector 320 may itself be connectable to a first PSU 340, while the second PSU connector 330 may be connectable to a second PSU 350. In non-limiting examples, the PSUs 340, 350 may be 12-volt (V) PSUs. Each PSU 340, 350 may provide power from a power source such as a wall outlet to the MB 200 according to either or both of a power-sharing mode and a power redundancy mode.

As mentioned above, the PDB 210 may be established by a PCB with copper-based circuits (and/or other types of circuits) to electrically couple the PSU connectors 320, 330 to the MB connector 250 to thus transfer power from the PSUs 340, 350 through the connectors 320, 330 to the MB connector 250. The MB connector 250 may also be electrically coupled to the MB 200 to, in turn, pass the power to other components on the MB 200 (e.g., to the CPUs 220, 225). Notably, it may be appreciated that the PSU connector 330 is located more proximate to the MB connector 250 than the PSU connector 320 is located to the MB connector 250, which would otherwise cause electrical imbalance on the PDB 210 absent present principles.

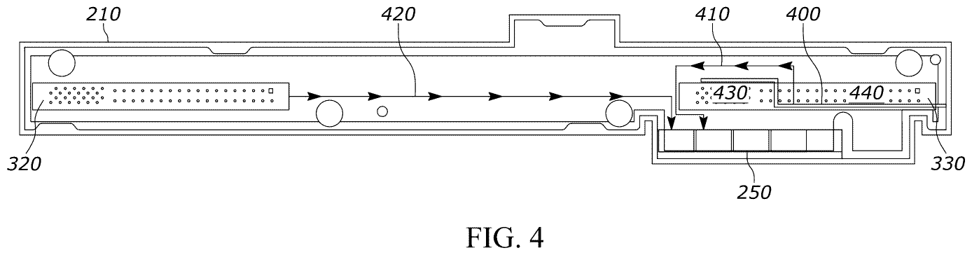

Turning now to FIG. 4, this figure shows a cross-sectional view of the PDB 210. Again note that the PDB 210 includes the MB 250 connector, the PSU connector 330 as electrically coupled to the MB connector 250, and the PSU connector 320 as also electrically coupled to the MB connector 250. Again note that the PSU connector 330 is located more proximate to the MB connector 250 than the PSU connector 320 is located to the MB connector 250. Also note that the MB connector 250 itself may include, in non-limiting examples, both 12V pins and ground pins.

FIG. 4 also shows that the PDB 210 further includes an area 400 that is generally Z-shaped as shown. The area 400 may be established by a non-conductive void/gap over which power from the PSU 350 cannot travel when connected to the PSU connector 330. Though not precisely shown to scale, it is to be understood that this configuration directs power from the PSU connector 330 to the MB connector 250 along a first electrical path 410 that has a first distance that is equal (e.g., to within a threshold tolerance) to a second distance of a second path 420 over which power travels from the PSU connector 320 to the MB connector 250. Thus, the first and second distances may be equal (zero tolerance), or equal to within a threshold non-zero tolerance that nonetheless results in an electrical imbalance that is negligible (e.g., two millimeters or up to ten millimeters).

In some non-limiting examples, the aforementioned area 400 may be established by an air gap or other void. In some examples, the void may be established by an etching in the copper or other metal of the PDB, though PDB may also be manufactured from scratch with the void already included. In addition to or in lieu of that, the area 400 may be filled with insulating material such as Fiberglass, FR4 glass epoxy, rubber, plastic, etc. to further prevent an overcurrent from the connector 330 from jumping across the area 400 and to the MB connector 250 along a path shorter than the path 410.

What's more, note that the Z-shape of the area 400 may be configured as such so that signal pins 430 on the connector 330 have a shorter path to the MB connector 250 than the path 410 that power from power pins 440 travels to reach the MB connector 250 (the other connector 320 itself having no such insulating area). Thus, non-power signals from the PSU 350 need not travel around the area 400 to reach the MB connector 450 as the power signals otherwise do. This is based on the recognition that non-power signals from the signal pins 430 may benefit from the shorter path yet not pose a danger to the MB 200 and its components during a power surge or other overcurrent situation.

It may therefore be appreciated based on FIG. 4 that the PSUs 340, 350 may supply power to the MB 200 according to a power sharing mode (power provided concurrently from both PSUs to the MB), advantageously with no electrical imbalance being created across the PDB 210 notwithstanding the connectors 320, 330 being unequal distances from the MB connector 250.

It is to be further understood that methods of manufacturing and providing the devices and components described herein are also encompassed by present principles.

Furthermore, in some instances a PDB might be provided by itself through channels of commerce even without the PSU connectors and MB connector already being included on the PDB. Thus, in one particular example, a PDB may include a first space for a first PSU connector, a second space for a second PSU connector, and a third space for an MB/PCB connector. The first and second spaces may be unequal distances from the third space, and the PDB may include an area that directs power along a first path from the first space to the third space. Here the first path still has a first distance that is equal to a second distance of a second path from the second space to the third space over which power can also travel.

Components included in one embodiment can be used in other embodiments in any appropriate combination. For example, any of the various components described herein and/or depicted in the Figures may be combined, interchanged or excluded from other embodiments.

It is to be understood that whilst present principles have been described with reference to some example embodiments, these are not intended to be limiting, and that various alternative arrangements may be used to implement the subject matter claimed herein. Accordingly, while particular techniques and devices are herein shown and described in detail, it is to be understood that the subject matter which is encompassed by the present application is limited only by the claims.

What is claimed is:

1. A device, comprising:
a power distribution board (PDB), the PDB comprising a motherboard (MB) connector, a first power supply unit (PSU) connector electrically coupled to the MB connector, and a second PSU connector electrically coupled to the MB connector, the first PSU connector being located more proximate to the MB connector than the second PSU connector is located to the MB connector;
an MB electrically coupled to the MB connector;
a processor system coupled to the MB; and
storage accessible to the processor system and coupled to the MB;
wherein the PDB further comprises a void to direct power from the first PSU connector to the MB connector along a first path that has a first distance that is equal, within a threshold tolerance, to a second distance of a second path over which power travels from the second PSU connector to the MB connector.

2. The device of claim 1, wherein the void is established by an etching in copper of the PDB.

3. The device of claim 1, wherein the threshold tolerance is less than ten millimeters.

4. The device of claim 1, wherein the first PSU connector connects the PDB to a first PSU, and wherein the second PSU connector connects the PDB to a second PSU.

5. The device of claim 4, wherein the first and second PSUs supply power to the device according to a power sharing mode.

6. The device of claim 4, comprising the first and second PSUs.

7. The device of claim 1, wherein the PDB is established by a printed circuit board.

8. The device of claim 1, wherein the MB connector connects the PDB to the MB via a through hole in the device.

9. The device of claim 1, wherein the storage comprises memory.

10. The device of claim 9, wherein the memory comprises one or more dual in-line memory modules (DIMMs).

11. The device of claim 1, wherein the processor system comprises two central processing units (CPUs) configured on the device to receive power, via the MB connector, from the PDB.

12. The device of claim 1, wherein the MB connector comprises golden fingers.

13. A device, comprising:
a power distribution board (PDB), the PDB comprising a printed circuit board (PCB) connector, a first power supply unit (PSU) connector electrically coupled to the PCB connector, and a second PSU connector electrically coupled to the PCB connector, the first PSU connector being located more proximate to the PCB connector than the second PSU connector is located to the PCB connector;
wherein the PDB further comprises an area that directs power from the first PSU connector to the PCB connector along a first path that has a first distance that is equal, within a threshold tolerance, to a second distance of a second path over which power travels from the second PSU connector to the PCB connector.

14. The device of claim 13, wherein the PCB connector is a motherboard (MB) connector that connects the PDB to an MB.

15. The device of claim 16, comprising the MB.

16. The device of claim 13, wherein the area comprises a non-conductive gap in the PDB.

17. The device of claim 18, wherein the non-conductive gap is established by an etching in metal on the PDB.

18. The device of claim 13, wherein the area comprises insulating material.

19. The device of claim 13, comprising a first PSU and a second PSU, wherein the first PSU connector connects the PDB to the first PSU, and wherein the second PSU connector connects the PDB to the second PSU.

20. A device, comprising:
a power distribution board (PDB), the PDB comprising a first space for a first power supply unit (PSU) connector, a second space for a second PSU connector, and a third space for a printed circuit board (PCB) connector, the first and second spaces being unequal distances from the third space, the PDB comprising an area that directs power along a first path from the first space to the third space, the first path having a first distance that is equal to a second distance of a second path from the second space to the third space over which power can also travel.
